(19) United States
(12) Patent Application Publication
(10) Pub. No.: US 2026/0031904 A1
(43) Pub. Date: Jan. 29, 2026

(54) OPTICAL SPACE COMMUNICATION DEVICE AND OPTICAL SPACE COMMUNICATION METHOD

(71) Applicant: NEC Corporation, Tokyo (JP)

(72) Inventor: Kenji WAKAFUJI, Tokyo (JP)

(73) Assignee: NEC Corporation, Tokyo (JP)

(21) Appl. No.: 19/262,808

(22) Filed: Jul. 8, 2025

(30) Foreign Application Priority Data
Jul. 23, 2024 (JP) 2024-117994

(51) Int. Cl. H04B 10/11

(52) U.S. Cl. CPC H04B 10/11

(57) ABSTRACT

An optical space communication device includes a transmitter for transmitting a first signal for optical axis alignment with another optical space communication device including a reflector, the first signal being modulated using a first spreading code, and a receiver for detecting, from a received optical signal, a reflected signal of the first signal reflected by a reflector of the other optical space communication device using the first spreading code, and detecting, from a received optical signal, a second signal for optical space communication transmitted from the other optical space communication device using a second spreading code different from the first spreading code.

### TECHNICAL FIELD

The present disclosure relates to an optical space communication device and an optical space communication method.

### BACKGROUND ART

Optical space communication (also referred to as free-space optics (FSO)) that performs communication using light propagating in free space has been developed. In optical space communication, it is necessary to perform optical axis alignment between communication devices. As a method of optical axis alignment, techniques described in JP 2015-65492 A and Optical Communications Terminal (OCT) Standard (Space Development Agency (SDA), Version 3.1.0, 2023 Mar. 31) are known.

JP 2015-65492 A describes that an optical signal is transmitted from one communication device to the other communication device while changing an emission mode, and the other communication device that has received the optical signal transmits a control signal generated based on the optical signal to the one communication device.

Optical Communications Terminal (OCT) Standard (Space Development Agency (SDA), Version 3.1.0, 2023 Mar. 31) describes that scanning is alternately performed with one of the communication devices as a master and the other as a slave.

### SUMMARY

In the optical axis alignment described in JP 2015-65492 A and Optical Communications Terminal (OCT) Standard (Space Development Agency (SDA), Version 3.1.0, 2023 Mar. 31), it is necessary to start the optical axis alignment at the same timing between the optical space communication devices.

The present disclosure has been made in view of the above problems, and an exemplary object of the present disclosure is to provide a technology capable of starting optical axis alignment without timing alignment between optical space communication devices.

An optical space communication device according to an exemplary aspect of the present disclosure includes: a transmission means; and a reception means, wherein the transmission means is configured to execute: transmitting a first signal for optical axis alignment with another optical space communication device including a reflector, the first signal being modulated using a first spreading code, and the reception means is configured to execute: detecting, from a received optical signal, a reflected signal of the first signal reflected by a reflector of the other optical space communication device using the first spreading code; and detecting, from a received optical signal, a second signal for optical space communication transmitted from the other optical space communication device using a second spreading code different from the first spreading code.

An optical space communication method according to an exemplary aspect of the present disclosure is an optical space communication method executed by an optical space communication device, including: transmitting a first signal for optical axis alignment with another optical space communication device including a reflector, the first signal being modulated using a first spreading code; detecting, from a received optical signal, a reflected signal of the first signal reflected by a reflector of the other optical space communication device using the first spreading code; and detecting, from a received optical signal, a second signal for optical space communication transmitted from the other optical space communication device using a second spreading code different from the first spreading code.

According to an exemplary aspect of the present disclosure, there is an exemplary effect that it is possible to provide a technology capable of starting optical axis alignment without timing alignment between optical space communication devices.

### BRIEF DESCRIPTION OF THE DRAWINGS

FIG. 1 is a block diagram illustrating a configuration of an optical space communication device according to the present disclosure;

FIG. 2 is a flowchart illustrating a flow of an optical space communication method according to the present disclosure;

FIG. 3 is a block diagram illustrating a configuration of an optical space communication device according to the present disclosure;

FIG. 4 is a diagram for explaining an optical axis alignment operation of the optical space communication device according to the present disclosure;

FIG. 5 is a diagram for explaining an optical axis alignment operation and an optical space communication operation of the optical space communication device according to the present disclosure;

FIG. 6 is a diagram illustrating an example of a reception level of a received optical signal in a case where a signal level of a direct wave is larger than a signal level of a reflected wave in the optical space communication device according to the present disclosure;

FIG. 7 is a diagram illustrating an example of a reception level of an optical signal after clipping is performed in the optical space communication device according to the present disclosure; and

FIG. 8 is a block diagram illustrating a configuration of a computer that functions as an optical space communication device according to the present disclosure.

### EXAMPLE EMBODIMENT

Hereinafter, example embodiments of the present invention will be described. However, the present invention is not limited to the example embodiments described below, and various changes may be made within the scope described in the claims. For example, example embodiments obtained by appropriately combining techniques (some or all of things or methods) adopted in the following example embodiments can also be included in the scope of the present invention. In addition, example embodiments obtained by appropriately omitting some of the techniques adopted in the following example embodiments can also be included in the scope of the present invention. In addition, effects mentioned in the following example embodiments are examples of effects expected in the example embodiments, and do not define the extension of the present invention. That is, example embodiments that do not achieve the effects mentioned in the following example embodiments can also be included in the scope of the present invention.

### First Example Embodiment

A first example embodiment, which is an example of an example embodiment of the present invention, will be described in detail with reference to the drawings. The present example embodiment is a basic form of each example embodiment described below. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in the drawings referred to for describing the present example embodiment can also be adopted in the other example embodiments included in the present disclosure within a range in which no particular technical problem occurs.

### (Configuration of Optical Space Communication Device)

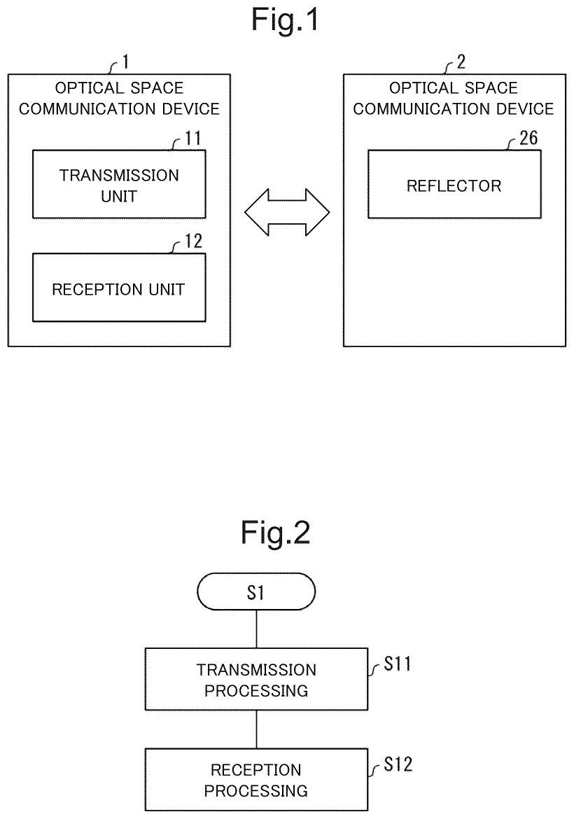

A configuration of an optical space communication device 1 will be described with reference to FIG. 1. FIG. 1 is a block diagram illustrating a configuration of the optical space communication device 1. For convenience of description, FIG. 1 illustrates not only the optical space communication device 1 but also an optical space communication device 2 (another optical space communication device) which is a communication partner of the optical space communication device 1.

As illustrated in FIG. 1, the optical space communication device 1 includes a transmission unit (transmission means) 11 and a reception unit (reception means) 12. As illustrated in FIG. 1, the optical space communication device 2 includes a reflector 26. The reflector 26 is, for example, a passive reflector such as a corner cube reflector (CCR) or a retroreflection plate, and can be configured to reflect light in a direction toward a transmission source thereof.

The transmission unit 11 has a function of transmitting an optical signal. In the present example embodiment, the transmission unit 11 transmits a first signal for optical axis alignment with the optical space communication device 2 modulated using a spreading code (first spreading code) for optical axis alignment. The spreading code may be, for example, a spreading code such as an optical orthogonal code (OOC) or a prime code used in the optical CDMA technology.

The reception unit 12 has a function of receiving an optical signal. In the present example embodiment, the reception unit 12 detects, from the received optical signal, a reflected signal of the first signal reflected by the reflector 26 of the optical space communication device 2 using a spreading code (first spreading code) for optical axis alignment.

The reception unit 12 detects, from the received optical signal, a second signal for optical space communication transmitted from the optical space communication device 2 using a spreading code (second spreading code) for reception by optical space communication different from the spreading code (first spreading code) for optical axis alignment.

### (Effects of Optical Space Communication Device)

As described above, the optical space communication device 1 adopts a configuration in which the first signal for optical axis alignment with the optical space communication device 2 is reflected by the reflector 26 of the optical space communication device 2 and received by the reception unit 12. Furthermore, the optical space communication device 1 employs a configuration in which the reflected signal of the first signal reflected by the reflector 26 of the optical space communication device 2 is detected using the spreading code (first spreading code) for optical axis alignment, and the second signal for optical space communication transmitted from the optical space communication device 2 is detected using the spreading code (second spreading code) for reception by optical space communication different from the spreading code (first spreading code) for optical axis alignment. Therefore, according to the optical space communication device 1, even in a state where the optical axis alignment has not started in the optical space communication device 2 and the second signal for optical space communication is transmitted from the optical space communication device 2, the optical axis alignment can be started by transmitting the first signal. As a result, it is possible to obtain an effect that the optical axis alignment can be started without matching the timing between the optical space communication devices.

### (Flow of Optical Space Communication Method)

A flow of an optical space communication method S1 will be described with reference to FIG. 2. FIG. 2 is a flowchart illustrating a flow of the optical space communication method S1. The optical space communication method S1 is executed by the optical space communication device 1, and includes a transmission process S11 and a reception process S12 as illustrated in FIG. 2.

In the transmission process S11, the optical space communication device 1 transmits a first signal for optical axis alignment with the optical space communication device 2 (another optical space communication device) provided with the reflector 26, the first signal being modulated using a spreading code (first spreading code) for optical axis alignment.

In the reception process S12, the optical space communication device 1 detects, from the received optical signal, the reflected signal of the first signal reflected by the reflector 26 of the optical space communication device 2 using the spreading code (first spreading code) for optical axis alignment.

In the reception process S12, the optical space communication device 1 detects, from the received optical signal, the second signal for optical space communication which is transmitted from the optical space communication device 2 by using a spreading code (second spreading code) for reception by optical space communication different from the spreading code (first spreading code) for optical axis alignment.

### (Effects of Optical Space Communication Method)

As described above, in the optical space communication method S1, a configuration is adopted in which the first signal for optical axis alignment with the optical space communication device 2 is reflected by the reflector 26 of the optical space communication device 2 and received by the optical space communication device 1. Furthermore, in the optical space communication method S1, a configuration is adopted in which the reflected signal of the first signal reflected by the reflector 26 of the optical space communication device 2 is detected using the spreading code (first spreading code) for optical axis alignment, and the second signal for optical space communication transmitted from the optical space communication device 2 is detected using the spreading code (second spreading code) for reception by optical space communication different from the spreading code (first spreading code) for optical axis alignment. Therefore, according to the optical space communication method S1, even in a state where the optical axis alignment has not started in the optical space communication device 2 and the second signal for optical space communication is transmitted from the optical space communication device 2, the optical axis alignment can be started by transmitting the first signal. As a result, it is possible to obtain an effect that the optical axis alignment can be started without matching the timing between the optical space communication devices.

### Second Example Embodiment

A second example embodiment, which is an example of an example embodiment of the present invention, will be described in detail with reference to the drawings. Components having the same functions as the components described in the above-described example embodiment will be denoted by the same reference numerals, and the description thereof will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in each of the drawings referred to for description of the present example embodiment can be employed in the other example embodiments included in the present disclosure within a range in which no particular technical problem occurs.

### (Configuration of Optical Space Communication Device)

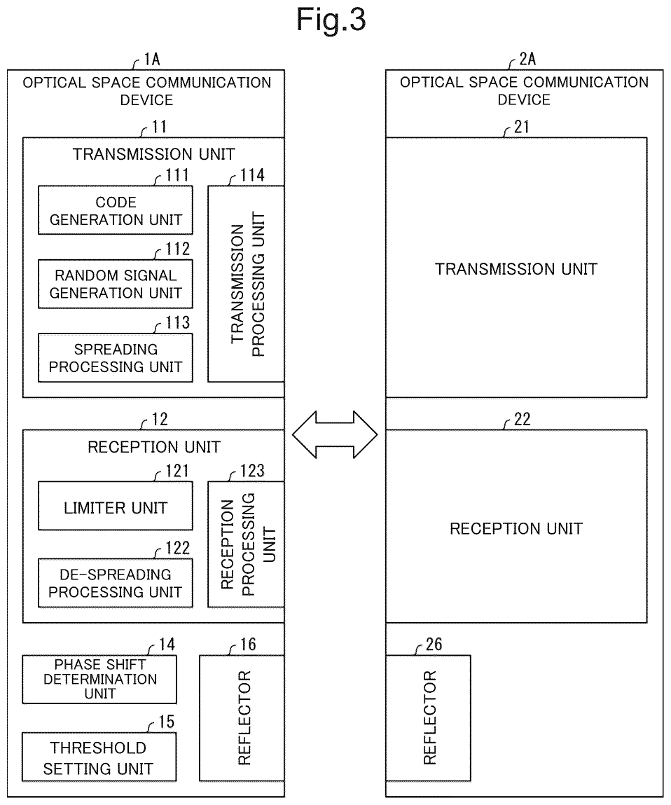

A configuration of an optical space communication device 1A will be described with reference to FIG. 3. FIG. 3 is a block diagram illustrating a configuration of the optical space communication device 1A. For convenience of description, FIG. 3 illustrates not only the optical space communication device 1A but also an optical space communication device 2A (another optical space communication device) which is a communication partner of the optical space communication device 1A. However, the configuration of the optical space communication device 2A is simplified.

The optical space communication device 1A includes a phase shift determination unit (control means) 14, a threshold setting unit (setting means) 15, and a reflector 16 in addition to the transmission unit (transmission means) 11 and the reception unit (reception means) 12 included in the optical space communication device 1.

The transmission unit 11 has a function of transmitting an optical signal. The transmission unit 11 transmits a first signal for optical axis alignment with the optical space communication device 2, the first signal being modulated using a spreading code (first spreading code) for optical axis alignment. The transmission unit 11 transmits a third signal for optical space communication which is modulated using a spreading code (third spreading code) for transmission to the optical space communication device 2 by optical space communication.

Specifically, the transmission unit 11 may include a code generation unit 111. The code generation unit 111 generates a spreading code based on a parameter. The spreading code may be, for example, a spreading code such as an optical orthogonal code (OOC) or a prime code used in the optical CDMA technology.

The parameter may be input to the optical space communication device 1 in advance or may be notified to the optical space communication device 1. The code generation unit 111 can generate different spreading codes by using different parameters. For example, the code generation unit 111 may generate a spreading code (first spreading code) for optical axis alignment, a spreading code (second spreading code) for reception by optical space communication, and a spreading code (third spreading code) for transmission to the optical space communication device 2 by optical space communication.

The transmission unit 11 may include a random signal generation unit 112. The random signal generation unit 112 generates a signal to be transmitted at random timing.

The transmission unit 11 may include a spreading processing unit 113. The spreading processing unit 113 modulates the transmission signal using the spreading code generated by the code generation unit 111.

The transmission unit 11 may include a transmission processing unit 114. The transmission processing unit 114 transmits the signal modulated by the spreading processing unit 113 as an optical signal.

The reception unit 12 has a function of receiving an optical signal. The reception unit 12 detects, from the received optical signal, a reflected signal of the first signal reflected by the reflector 26 of the optical space communication device 2 using the spreading code (first spreading code) for optical axis alignment. The reception unit 12 detects, from the received optical signal, a second signal for optical space communication transmitted from the optical space communication device 2 using a spreading code (second spreading code) for reception by optical space communication different from the spreading code (first spreading code) for optical axis alignment.

Specifically, the reception unit 12 may include a reception processing unit 121. The reception processing unit 121 receives and converts the optical signal into a received signal.

The reception unit 12 may include a limiter unit 122. The limiter unit 122 performs clipping processing on the received signal so that the signal level of the received signal is equal to or less than a threshold.

The reception unit 12 may include a de-spreading processing unit 123. The de-spreading processing unit 123 detects a desired signal by demodulating the received signal using a spreading code.

The phase shift determination unit 14 determines that the optical space communication device 1A performs at least one of an optical axis alignment operation (reflected wave phase) of performing optical axis alignment with the optical space communication device 2A and an optical space communication operation (direct wave phase) of performing optical space communication with the optical space communication device 2A.

In one aspect, the phase shift determination unit 14 may determine to perform the optical space communication operation as long as the direction of the optical space communication device 2A can be determined in the optical axis alignment operation. The phase shift determination unit 14 may determine to perform the optical axis alignment operation when communication with the optical space communication device 2A is disconnected in the optical space communication operation.

The threshold setting unit 15 sets a threshold used by the limiter unit 122.

The reflector 16 is a passive reflector such as a corner cube reflector (CCR) or a retroreflection plate, and can be configured to reflect light in a direction toward a transmission source thereof.

The optical space communication device 2A is a device having a configuration equivalent to that of the optical space communication device 1A, and a detailed description thereof will be omitted. In order to avoid complexity, FIG. 3 illustrates the transmission unit 21, the reception unit 22, and the reflector 26 among the configurations included in the optical space communication device 2A. The transmission unit 21 has the same configuration as the transmission unit 11, the reception unit 22 has the same configuration as the reception unit 12, and the reflector 26 has the same configuration as the reflector 16.

### (Optical Axis Alignment Operation)

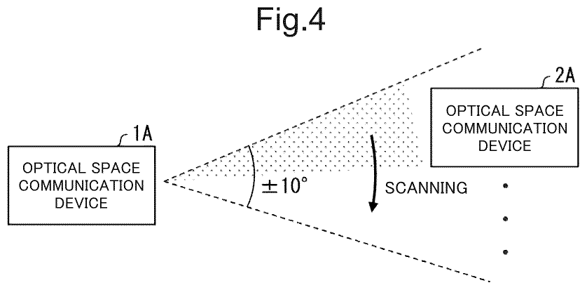

The optical axis alignment operation of the optical space communication device 1A will be described. FIG. 4 is a diagram for explaining an optical axis alignment operation of the optical space communication device 1A. As illustrated in FIG. 4, in the optical axis alignment operation, the optical space communication device 1A searches for the direction of the optical space communication device 2A by transmitting the first signal while changing the direction.

In the present example embodiment, the optical space communication device 1A can start optical axis alignment at a unique timing. Even if the optical space communication device 2A does not know that the optical axis alignment is started by the optical space communication device 1A, the optical space communication device 1A transmits the first signal for the optical axis alignment to the optical space communication device 2A, and detects the reflected signal of the first signal reflected by the reflector 26 of the optical space communication device 2A, so that the direction of the optical space communication device 2A can be searched for without depending on the reception processing of the optical space communication device 2A.

The first signal transmitted by the optical space communication device 1A has a certain extent of spread. Therefore, it is assumed that both the reception unit 22 and the reflector 26 of the optical space communication device 2A are irradiated when the optical space communication device 2A is irradiated with light.

In the present example embodiment, it is assumed that the reflector 26 is irradiated with light at an angle (for example, a range of approximately 20 degrees) at which the reflector 26 can reflect the light in a direction toward a transmission source thereof. In one aspect, the orientations of the optical space communication device 1A and the optical space communication device 2A may be adjusted according to the mutual positional relationship. The positional relationship between the optical space communication device 1A and the optical space communication device 2A can be specified from, for example, a GPS (not illustrated) provided in the optical space communication device 1A and the optical space communication device 2A, or arrangement information of the optical space communication device 1A and the optical space communication device 2A.

In one aspect, the reception unit 12 has the light receiving angle relevant to the scanning angle of the transmission unit 11, so that the reflected signal of the first signal can be reliably received. Therefore, the reception unit 12 may include an optical system such as a lens for widening the light receiving angle, a light receiving element array, a mechanism for causing the orientation of the reception unit 12 to follow the transmission direction of the transmission unit 11, and the like.

(Transition between Optical Axis Alignment Operation and Optical Space Communication Operation)

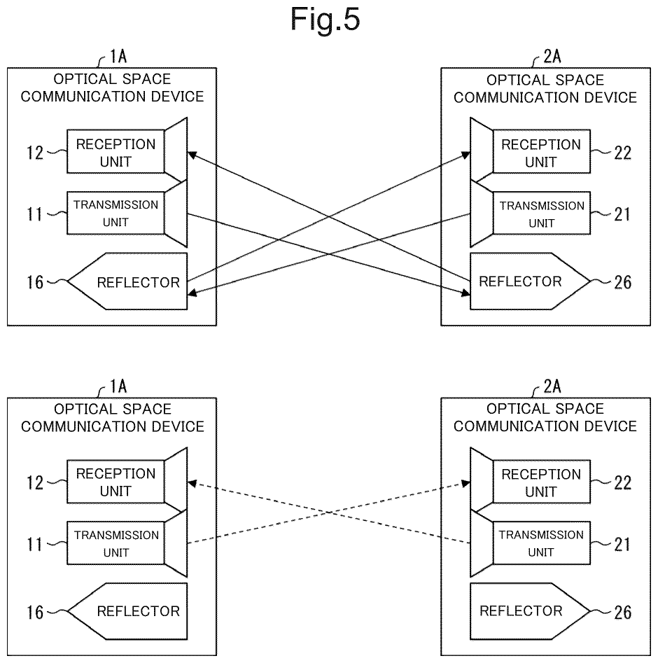

FIG. 5 is a diagram for explaining an optical axis alignment operation (reflected wave phase) and an optical space communication operation (direct wave phase). FIG. 5 illustrates a scene in which the optical space communication device 1A and the optical space communication device 2A perform the same operation (phase), but the operations (phases) of the optical space communication device 1A and the optical space communication device 2A may be different from each other.

As illustrated in the upper part of FIG. 5, in the optical axis alignment operation (reflected wave phase), the transmission unit 11 of the optical space communication device 1A transmits the first signal for optical axis alignment, the transmitted first signal is reflected by the reflector 26 of the optical space communication device 2A, and the reception unit 12 of the optical space communication device 1A detects the reflected signal of the first signal. The transmission unit 21 of the optical space communication device 2A transmits a fourth signal for optical axis alignment, the transmitted fourth signal is reflected by the reflector 16 of the optical space communication device 1A, and the reception unit 22 of the optical space communication device 2A detects a reflected signal of the fourth signal. In the optical axis alignment operation, since the reflected signal (reflected wave) is received by each reception unit, a phase in which the optical axis alignment operation is performed is also referred to as a reflected wave phase.

As illustrated in the lower part of FIG. 5, in the optical space communication operation (direct wave phase), the transmission unit 21 of the optical space communication device 2A transmits the second signal for optical space communication, and the reception unit 12 of the optical space communication device 1A detects the second signal. The transmission unit 11 of the optical space communication device 1A transmits the third signal for optical space communication, and the reception unit 22 of the optical space communication device 2A detects the third signal. In the optical space communication operation, since a signal (direct wave) that is not reflected is received by each reception unit, a phase in which the optical space communication operation is performed is also referred to as a direct wave phase.

In the optical axis alignment operation (reflected wave phase), the phase shift determination unit 14 of the optical space communication device 1A executes the optical space communication operation (direct wave phase) for performing bidirectional transmission and reception after the azimuth search for the other party is completed using the reflected signal, thereby establishing a direct wave communication system. After transitioning to the optical space communication operation, the optical axis alignment operation is executed again due to a fluctuation of an azimuth angle error caused by an oscillation of the device due to wind or vibration. In the phase shift determination unit 14 of the optical space communication device 1A, the control means may cause at least a part of the optical axis alignment operation and at least a part of the optical space communication operation to be executed in an overlapping manner. The phase shift determination unit of the optical space communication device 2A may operate similarly.

What is important here is whether it is possible to smoothly transition from the optical axis alignment operation to the optical space communication operation in order to achieve the optical space communication by the final direct wave. Although the reflector and the transmission unit are in the same device, the signal level entering the reception unit may be different due to the positional deviation between the devices because positions are different depending on the devices, but there is a risk that the hard switching from the configuration of receiving the reflected wave to the configuration of receiving the direct wave requires readjustment.

In the present example embodiment, in the optical space communication device 1A, both the first signal reflected by the reflector 26 of the optical space communication device 2A in the optical axis alignment operation and the second signal transmitted from the transmission unit 21 of the optical space communication device 2A in the optical space communication operation are received by the same reception unit 12, and are detected by the spreading code. Similarly, in the optical space communication device 2A, the fourth signal reflected by the reflector 16 of the optical space communication device 1A in the optical axis alignment operation and the third signal transmitted from the transmission unit 11 of the optical space communication device 1A in the optical space communication operation are received by the same reception unit 12, and are detected by the spreading code.

As described above, in the present example embodiment, the reception unit simultaneously identifies the reflected wave and the direct wave, thereby reducing the risk of readjustment. Since the reflected wave is continuously received even after the final adjustment with the direct wave is started in the optical space communication operation, it is easy to return to the optical axis alignment operation.

### (Detection of Signal Using Spreading Code)

In the present example embodiment, a signal is detected using a spreading code, for example, in an optical CDMA system. Specifically, intermittent transmission (pulse transmission) by a pulse signal modulated using a spreading code is performed.

By performing intermittent transmission (pulse transmission), it is possible to increase the output. The reception sensitivity can be improved by integrating the pulse signals. This makes it possible to scan a long distance and a wide range.

By detecting the signal using the spreading code in the time domain, it is possible to achieve cost reduction by eliminating the need for a new optical system device such as a different wavelength or polarization.

In the optical axis alignment operation (reflected wave phase), when the directions of the devices face each other, a phenomenon of continuing reflection between reflectors may occur, but the received power decreases for each reflection, and thus the influence is basically small. Even if there is an influence, it can be handled by rake reception performed by wireless communication using spreading codes.

For example, among the optical signals received by the reception unit 12 of the optical space communication device 1A, the second signal (direct wave) may have a signal level larger than that of the reflected signal (reflected wave) of the first signal due to a difference in propagation distance, reflection loss, or the like, and the reflected signal (reflected wave) of the first signal may be buried.

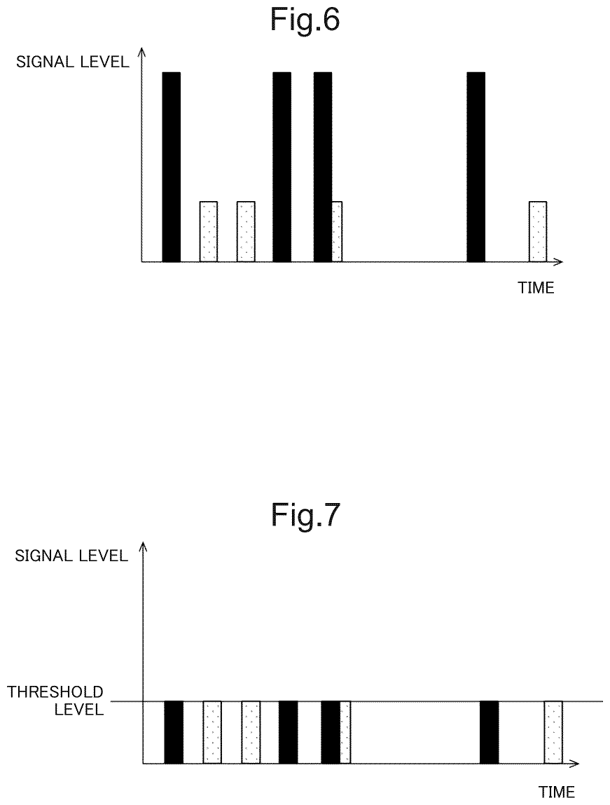

FIG. 6 is a diagram illustrating an example of a reception level of a received optical signal in a case where a signal level of a direct wave is larger than a signal level of a reflected wave. As illustrated in FIG. 6, in a case where the signal level of the direct wave is several times higher than that of the reflected wave, there is a case where the reflected wave cannot be accurately detected because the noise of the direct wave is large when the de-spreading processing is performed using the spreading code.

In order to solve such a problem, in one aspect, the reception unit 12 may clip the received optical signal so that the signal level becomes the threshold level or less, detect the reflected signal of the first signal from the clipped optical signal in the optical axis alignment operation, and detect the second signal from the clipped optical signal in the optical space communication operation. In one aspect, the threshold level is set to be closer to the signal level of the reflected signal of the first signal than the signal level of the second signal.

FIG. 7 is a diagram illustrating an example of a reception level of an optical signal after clipping is performed. As illustrated in FIG. 7, by performing clipping, the signal level of the direct wave is brought close to the signal level of the reflected wave, whereby the reflected wave can be accurately detected when the de-spreading processing is performed using the spreading code.

In one aspect, the threshold setting unit 15 may set the threshold level. As the threshold level, it is preferable that the direct wave that becomes the unnecessary wave is reduced to at least a signal level of the reflected wave, but this varies depending on the distance between the transceivers and the propagation situation. In particular, the propagation situation may change due to the influence of atmospheric fluctuations.

In the present example embodiment, the threshold setting unit 15 may set the threshold level by the following processing. First, the transmission unit 11 transmits the first signal at a random timing a plurality of times. Then, the threshold setting unit 15 may set the threshold level based on the lowest level in the reception levels of the reflected signals of the first signals transmitted a plurality of times.

That is, by repeating the transmission of the first signal a plurality of times, only the reflected signal of the first signal can be received at least once at a timing not overlapping with the second signal. In particular, by setting the transmission timing of the first signal to be random, it is possible to further avoid overlapping with the second signal. The lowest level in the reception level of the reflected signal of the first signal transmitted a plurality of times is regarded as relevant to the reception level in which only the reflected signal of the first signal is received, and the threshold level can be set based on the lowest level. For example, the threshold level may be set to the lowest level, or a value shifted by a certain width from the lowest level may be set as the threshold level.

Furthermore, in order to reduce the influence of atmospheric fluctuations, the transmission unit 11 may perform a plurality of sets of transmitting the first signal a plurality of times, and the threshold setting unit 15 may aggregate the lowest levels of the reception levels of the reflected signals of the first signal in each set and set the threshold level based on an average value thereof.

### (Effects of Optical Space Communication Device)

The application scene of the optical space communication device 1A is not particularly limited, but for example, it is possible to configure a network that sequentially follows the situation (progress of the process) at a construction site or the like. In such a network, work loads and labor such as construction on the premise of temporary operation may be reduced, and a network (FSO link) by optical space communication using an optical space communication technology is suitable. Examples thereof include a portable temporary network and a mobile network by FSO, and a multi-hop wireless network by FSO.

However, since the FSO link has very high directivity and is greatly affected by positional deviation between transmission and reception with respect to wind and vibration, it is very useful to provide a mechanism that can tolerate this.

In the optical space communication device 1A, the optical axis alignment can be started asynchronously without matching the timing between the connected communication devices, and each communication device can be established with a flat configuration without requiring pre-adjustment such as master slave. It is also possible to support long-distance or wide-angle scanning by intermittent transmission (pulse transmission). By using the reflector, it is possible to minimize the number of devices that affect the cost, such as laser diodes, from the viewpoint of cost reduction. Furthermore, the movement between the optical axis alignment operation (reflected wave phase) and the optical space communication operation (direct wave phase) can be smoothly performed.

Specifically, in the optical space communication device 1A, a configuration is adopted in which the reception unit 12 clips the received optical signal so that the signal level becomes equal to or less than a threshold level, detects the reflected signal of the first signal from the clipped optical signal, and detects the second signal from the clipped optical signal. The threshold level is set to be closer to the signal level of the reflected signal of the first signal than the signal level of the second signal. Therefore, according to the optical space communication device 1A, in addition to the effect obtained by the optical space communication device 1, it is possible to obtain an effect of accurately detecting the reflected signal of the first signal.

In the optical space communication device 1A, a configuration is adopted in which the threshold setting unit 15 is further included which sets a threshold level, the transmission unit 11 transmits the first signal a plurality of times, and the threshold setting unit 15 sets the threshold level based on the lowest level in the reception levels of the reflected signals of the first signal transmitted a plurality of times. Therefore, according to the optical space communication device 1A, it is possible to further obtain an effect that an appropriate threshold level for clipping can be set.

In the optical space communication device 1A, a configuration is adopted in which the transmission unit 11 transmits the first signal at a random timing a plurality of times. Therefore, according to the optical space communication device 1A, it is possible to further obtain an effect that an appropriate threshold level for clipping can be set.

In the optical space communication device 1A, a configuration is adopted in which the transmission unit 11 performs a plurality of sets of transmitting the first signal a plurality of times, and the threshold setting unit 15 sets the threshold level based on the average value of the lowest levels of the reception levels of the first signals in the sets. Therefore, according to the optical space communication device 1A, it is possible to further obtain an effect that an appropriate threshold level for clipping can be set.

The optical space communication device 1A further includes the phase shift determination unit 14 that causes the optical space communication device 1A to execute at least one of the optical axis alignment operation and the optical space communication operation. The transmission unit 11 transmits the first signal in the optical axis alignment operation, transmits the third signal for the optical space communication in the optical space communication operation, and the reception unit 12 detects the reflected signal of the first signal in the optical axis alignment operation and detects the second signal in the optical space communication operation. Therefore, according to the optical space communication device 1A, in addition to the effect obtained by the optical space communication device 1, an effect of being able to smoothly transition between the optical axis alignment operation and the optical space communication operation can be obtained.

In the optical space communication device 1A, a configuration is adopted in which the phase shift determination unit 14 causes at least a part of the optical axis alignment operation and at least a part of the optical space communication operation to be executed in an overlapping manner. Therefore, according to the optical space communication device 1A, it is possible to further obtain an effect of smoothly transitioning between the optical axis alignment operation and the optical space communication operation.

The optical space communication device 1A employs a configuration further including a reflector 16. Therefore, according to the optical space communication device 1A, in addition to the effect obtained by the optical space communication device 1, an effect of enabling the optical space communication device 2A to perform optical axis alignment similarly to the optical space communication device 1A can be obtained.

In the optical space communication device 1A, a configuration is adopted in which the transmission unit 11 changes the transmission direction of the first signal. Therefore, according to the optical space communication device 1A, it is possible to obtain an effect of suitably searching for the direction of the optical space communication device 2A.

### [Example of Implementation by Software]

Some or all of the functions of the optical space communication devices 1 and 1A (hereinafter, also referred to as “each of the above apparatuses”) may be implemented by hardware such as an integrated circuit (an IC chip) or may be implemented by software.

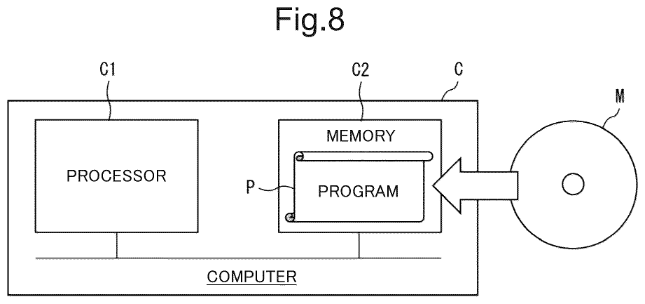

In the latter case, each of the above apparatuses is implemented by, for example, a computer that executes a command of a program which is software for implementing each function. An example of such a computer (hereinafter, referred to as a computer C) is illustrated in FIG. 8. FIG. 8 is a block diagram illustrating a hardware configuration of the computer C functioning as each of the above apparatuses.

The computer C includes at least one processor C1 and at least one memory C2. A program P for causing the computer C to operate as each of the above apparatuses is recorded in the memory C2. In the computer C, the processor C1 reads the program P from the memory C2 and executes the program P to implement each function of each of the above devices.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be implemented by a single processor provided in a single computer, may be implemented by cooperation of a plurality of processors provided in a single computer, or may be implemented by cooperation of a plurality of processors provided in a plurality of computers, respectively. The program for causing each of the above apparatuses to implement each of the above functions may be stored in a single memory provided in a single computer, may be stored in a distributed manner in a plurality of memories provided in a single computer, or may be stored in a distributed manner in a plurality of memories provided in a plurality of computers, respectively.

### Supplementary Matter 1

The present disclosure includes the techniques described in the following supplementary notes. However, the present invention is not limited to the techniques described in the following supplementary notes, and various modifications can be made within the scope described in the claims.

### (Supplementary Note 1)

An optical space communication device, including:
a transmission means; and
a reception means, in which
the transmission means is configured to execute:
transmitting a first signal for optical axis alignment with another optical space communication device including a reflector, the first signal being modulated using a first spreading code, and
the reception means is configured to execute:
detecting, from a received optical signal, a reflected signal of the first signal reflected by a reflector of the other optical space communication device using the first spreading code; and
detecting, from a received optical signal, a second signal for optical space communication transmitted from the other optical space communication device using a second spreading code different from the first spreading code.

### (Supplementary Note 2)

The optical space communication device according to Supplementary Note 1, in which
the reception means is configured to execute:
clipping a received optical signal in such a way that a signal level is equal to or less than a threshold level;
detecting a reflected signal of the first signal from a clipped optical signal; and
detecting the second signal from a clipped optical signal, and
the threshold level is set to be closer to a signal level of a reflected signal of the first signal than a signal level of the second signal.

### (Supplementary Note 3)

The optical space communication device according to Supplementary Note 2, further including:
a setting means for setting the threshold level, in which
the transmission means is configured to execute:
transmitting the first signal a plurality of times, and
the setting means is configured to execute:
setting the threshold level based on a lowest level in reception levels of reflected signals of the transmitted first signals the plurality of times.

### (Supplementary Note 4)

The optical space communication device according to Supplementary Note 3, in which the transmission means is configured to execute transmitting the first signal a plurality of times at random timing.

### (Supplementary Note 5)

The optical space communication device according to Supplementary Note 3 or 4, in which
the transmission means is configured to execute:
performing a plurality of sets of transmitting the first signal a plurality of times, and
the setting means is configured to execute:
setting the threshold level based on an average value of the lowest levels of reception levels of the first signals in the sets.

### (Supplementary Note 6)

The optical space communication device according to any one of Supplementary Notes 1 to 5, further including:
a control means for causing the optical space communication device to execute at least one of an optical axis alignment operation and an optical space communication operation, in which
the transmission means is configured to execute:
transmitting the first signal in the optical axis alignment operation; and
transmitting a third signal for optical space communication in the optical space communication operation, and
the reception means is configured to execute:
detecting a reflected signal of the first signal in the optical axis alignment operation; and
detecting the second signal in the optical space communication operation.

### (Supplementary Note 7)

The optical space communication device according to Supplementary Note 6, in which the control means is configured to execute:
performing at least a part of the optical axis alignment operation and at least a part of the optical space communication operation in an overlapping manner.

### (Supplementary Note 8)

The optical space communication device according to any one of Supplementary Notes 1 to 7, further including a reflector.

### (Supplementary Note 9)

The optical space communication device according to any one of Supplementary Notes 1 to 8, in which the transmission means is configured to execute:
changing a transmission direction of the first signal.

### (Supplementary Note 10)

An optical space communication method executed by an optical space communication device, the method including:
transmitting a first signal for optical axis alignment with another optical space communication device including a reflector, the first signal being modulated using a first spreading code;
detecting, from a received optical signal, a reflected signal of the first signal reflected by a reflector of the other optical space communication device using the first spreading code; and
detecting, from a received optical signal, a second signal for optical space communication transmitted from the other optical space communication device using a second spreading code different from the first spreading code.

### (Supplementary Note 11)

An optical space communication program for causing a computer to operate as the optical space communication device according to any one of Supplementary Notes 1 to 11, the optical space communication program causing the computer to function as each of the means.

### Supplementary Matter 2

The present disclosure includes the techniques described in the following supplementary notes. However, the present invention is not limited to the techniques described in the following supplementary notes, and various modifications can be made within the scope described in the claims.

### (Supplementary Note 1)

An optical space communication device, including:
at least one processor, in which
the at least one processor is configured to execute:
transmission processing; and
reception processing,
in the transmission processing, the at least one processor is configured to execute:
transmitting a first signal for optical axis alignment with another optical space communication device including a reflector, the first signal being modulated using a first spreading code, and
in the reception processing, the at least one processor is configured to execute:
detecting, from a received optical signal, a reflected signal of the first signal reflected by a reflector of the another optical space communication device using a first spreading code; and
detecting, from a received optical signal, a second signal for optical space communication transmitted from the other optical space communication device using a second spreading code different from the first spreading code.

The optical space communication device may further include a memory. The memory may store a program for causing the at least one processor to execute each processing.

### (Supplementary Note 2)

The optical space communication device according to Supplementary Note 1, in which
in the reception processing, the at least one processor is configured to execute:
clipping a received optical signal in such a way that a signal level is equal to or less than a threshold level;
detecting a reflected signal of the first signal from a clipped optical signal; and
detecting the second signal from a clipped optical signal, and
the threshold level is set to be closer to a signal level of a reflected signal of the first signal than a signal level of the second signal.

### (Supplementary Note 3)

The optical space communication device according to Supplementary Note 2, in which
the at least one processor is further configured to execute setting processing of setting the threshold level,
in the transmission processing, the at least one processor is configured to execute:
transmitting the first signal a plurality of times, and
in the setting processing, the at least one processor is configured to execute:
setting the threshold level based on a lowest level in reception levels of reflected signals of the transmitted first signals the plurality of times.

### (Supplementary Note 4)

The optical space communication device according to Supplementary Note 3, in which, in the transmission processing, the at least one processor is configured to execute transmitting the first signal a plurality of times at random timing.

### (Supplementary Note 5)

The optical space communication device according to Supplementary Note 3 or 4, in which
in the transmission processing, the at least one processor is configured to execute:
performing a plurality of sets of transmitting the first signal a plurality of times, and
in the setting processing, the at least one processor is configured to execute:
setting the threshold level based on an average value of the lowest levels of reception levels of the first signals in the sets.

### (Supplementary Note 6)

The optical space communication device according to any one of Supplementary Notes 1 to 5, in which
the at least one processor is further configured to execute control processing for causing the optical space communication device to execute at least one of an optical axis alignment operation and an optical space communication,
in the transmission processing, the at least one processor is configured to execute:
transmitting the first signal in the optical axis alignment operation; and
transmitting a third signal for optical space communication in the optical space communication operation, and
in the reception processing, the at least one processor is configured to execute:
detecting a reflected signal of the first signal in the optical axis alignment operation; and
detecting the second signal in the optical space communication operation.

### (Supplementary Note 7)

The optical space communication device according to Supplementary Note 6, in which, in the control processing, the at least one processor is configured to execute:
performing at least a part of the optical axis alignment operation and at least a part of the optical space communication operation in an overlapping manner.

### (Supplementary Note 8)

The optical space communication device according to any one of Supplementary Notes 1 to 7, further including a reflector.

### (Supplementary Note 9)

The optical space communication device according to any one of Supplementary Notes 1 to 8, in which the at least one processor is configured to execute:
changing a transmission direction of the first signal.

1. An optical space communication device, comprising:
a transmitter; and
a receiver, wherein
the transmitter is configured to execute:
transmitting a first signal for optical axis alignment with another optical space communication device including a reflector, the first signal being modulated using a first spreading code, and
the receiver is configured to execute:
detecting, from a received optical signal, a reflected signal of the first signal reflected by a reflector of the other optical space communication device using the first spreading code; and
detecting, from a received optical signal, a second signal for optical space communication transmitted from the other optical space communication device using a second spreading code different from the first spreading code.

2. The optical space communication device according to claim 1, wherein
the receiver is configured to execute:
clipping a received optical signal in such a way that a signal level is equal to or less than a threshold level;
detecting a reflected signal of the first signal from a clipped optical signal; and
detecting the second signal from a clipped optical signal, and
the threshold level is set to be closer to a signal level of a reflected signal of the first signal than a signal level of the second signal.

3. The optical space communication device according to claim 2, further comprising:
a setting circuit for set the threshold level, wherein
the transmitter is configured to execute:
transmitting the first signal a plurality of times, and
the setting circuit is configured to execute:
setting the threshold level based on a lowest level in reception levels of reflected signals of the transmitted first signals the plurality of times.

4. The optical space communication device according to claim 3, wherein the transmitter is configured to execute transmitting the first signal a plurality of times at random timing.

5. The optical space communication device according to claim 3, wherein
the transmitter is configured to execute:
performing a plurality of sets of transmitting the first signal a plurality of times, and
the setting circuit is configured to execute:
setting the threshold level based on an average value of the lowest levels of reception levels of the first signals in the sets.

6. The optical space communication device according to claim 1, further comprising:
a controller configured to cause the optical space communication device to execute at least one of an optical axis alignment operation and an optical space communication operation, wherein
the transmitter is configured to execute:
transmitting the first signal in the optical axis alignment operation; and
transmitting a third signal for optical space communication in the optical space communication operation, and
the receiver is configured to execute:
detecting a reflected signal of the first signal in the optical axis alignment operation; and
detecting the second signal in the optical space communication operation.

7. The optical space communication device according to claim 6, wherein the controller is configured to execute:
performing at least a part of the optical axis alignment operation and at least a part of the optical space communication operation in an overlapping manner.

8. The optical space communication device according to claim 1, further comprising a reflector.

9. The optical space communication device according to claim 1, wherein the transmitter is configured to execute:
changing a transmission direction of the first signal.

10. An optical space communication method executed by an optical space communication device, the method comprising:
transmitting a first signal for optical axis alignment with another optical space communication device including a reflector, the first signal being modulated using a first spreading code;
detecting, from a received optical signal, a reflected signal of the first signal reflected by a reflector of the other optical space communication device using the first spreading code; and
detecting, from a received optical signal, a second signal for optical space communication transmitted from the other optical space communication device using a second spreading code different from the first spreading code.
